(19) United States
(12) Patent Application Publication
(10) Pub. No.: US 2007/0099160 A1
(43) Pub. Date: May 3, 2007

(54) Drag racing tree blocker and related method

(76) Inventor: Bruce Noland, Leesburg, VA (US)

Correspondence Address: NIXON & VANDERHYE, PC, 901 NORTH GLEBE ROAD, 11TH FLOOR, ARLINGTON, VA, 22203, US

(21) Appl. No.: 11/260,482

(22) Filed: Oct. 28, 2005

(51) Int. Cl. G09B 19/00

(52) U.S. Cl. 434/236

(57) ABSTRACT

A device for focusing a race car driver's vision on selected lights of a drag racing light tree comprising a card body having a pair of apertures formed therein; a first fastener component adapted to be attached to a vehicle in proximity to a windshield of the vehicle and a second fastener component secured to the card body thereby permitting attachment of the card body to the vehicle; and wherein the pair of apertures are sized and shaped to permit the driver of the vehicle to see only the selected lights of the light tree.

### BACKGROUND OF THE INVENTION

This invention relates to the field of auto racing and, more specifically, to a particular kind of auto racing known as drag racing.

In official or sanctioned drag races, two vehicles line up, side-by-side in designated lanes, and a unique starting procedure is utilized that is governed by a sequence of lights known as the “Christmas tree.” Referring to FIG. 3, the tree 22 is a double column of lights, one column for each lane or driver. The lights in each column are identical to the other and include pre-stage lights 24, stage lights 26, and a sequence of three yellow lights 28, 30, 32, a green light 34 and a red light 36. The pre-stage and stage lights 24, 26 are used to position the vehicles at very precise locations just short of the starting line and at the starting line, respectively. Under the official rules of drag racing, both vehicles must be pre-staged before either can move to the staged position, and both must be staged before the three yellow lights will come on in sequence, followed by the green start light. The red is used in the event of an improper start or other foul.

Because a drag race is often won or lost at the start—often a fraction of a second determines the outcome—drivers will attempt to anticipate the green light by accelerating at the third yellow light, recognizing that reaction time is not instantaneous, and that by the time the accelerator pedal is depressed and the vehicle actually starts to move, the green light will have lit.

It is therefore of critical importance for the driver to focus intensely on the Christmas tree without distraction, and without having to shift his/her field of vision during the light-sequencing process.

### BRIEF DESCRIPTION OF THE INVENTION

This invention relates to a card-like device that enables the driver to block a portion of his field of vision so as to concentrate on the Christmas tree (also referred to herein as the “starting tree,” “light tree” or, simply, “tree”) but only in limited fashion. Specifically, the driver can observe the pre-stage and stage lights for both drivers, and then see only one of the remaining lights (for example, the third yellow light) for his lane.

In an exemplary embodiment, the card-like device is constructed of a rectangular strip of relatively stiff but flexible material, such as PVC, paperboard, plastic, metal or other suitable material. The strip is provided with a first rectangular aperture in the form of a horizontally-oriented slot and a second round aperture located below and aligned with one side edge of the first aperture. The apertures are sized and arranged to match up or align with the pre-stage and stage lights for both lanes and one of the yellow lights or green light for the driver's lane.

Relatively simple fastening or securing techniques may be used to fix the card on the windshield, windshield frame or roll cage of the car in the precise location needed to permit the driver to see the related tree lights as mentioned above. Since all sanctioned drag race tracks are precisely the same in terms of lane set-up and tree location, the card needs only minor adjustment before any given race.

It will be appreciated that the card may be used regardless of which lane the car is in, simply by reversing the card. Thus, if the driver is in the left lane, the card is position with the round aperture below and at the left side edge of the rectangular horizontal slot, but if in the right lane, the driver will reverse the card so that the round aperture is below and at the right side edge of the rectangular horizontal slot. It is therefore advantageous to employ re-useable and simple fastening elements such as well-known hook-and-loop fasteners (such as Velcro® or the like), but other fasteners may be used as well.

Accordingly, in one aspect, the invention relates to a device for focusing a race car driver's vision on selected lights of a drag racing light tree comprising a card body having a pair of apertures formed therein; a first fastener component adapted to be attached to a vehicle on or in proximity to a windshield of the vehicle and a second fastener component secured to the card body thereby permitting attachment of the card body to the vehicle; and wherein the pair of apertures are sized and shaped to permit the driver of the vehicle to see only the selected lights of the light tree.

In another aspect, the invention relates to a card for blocking all of a plurality of lights on a drag racing light tree with the exception of a selected minority of the lights, the card comprising a card body formed with a relatively larger aperture and a relatively smaller aperture, wherein the relatively larger aperture enables viewing of more than one of the selected minority of the lights and the relatively smaller aperture enables viewing of only one other of the selected minority of the lights.

In another aspect, the invention relates to a kit comprising a kit for use in assisting a driver at the start of a drag race wherein starting of the race is governed by a light tree, the kit comprising a card body having at least a pair of light locating apertures therein; and at least one strip of fastener material sufficient to provide a first length of the fastener for application to a selected location on both sides of the card and a second strip of a complimentary fastener material adapted for attachment to a race vehicle thereby enabling the card body to be attached to the vehicle by interaction between the first and second strips of fastener material.

In still another aspect, the invention relates to a method of enabling a driver of a race car to effect a quick start from a starting line position in a drag race where the start of the race is governed by a light tree having, for each of two competing drivers in adjacent lanes, a pair of side-by-side pre-stage lights, a pair of side-by-side stage lights, and a column of single lights including three yellow and a green light, the method comprising: a) partially restricting vision of the driver so that, of all of the lights on the tree, he can see only the pre-stage and stage lights for both lanes and the lowermost of the three yellow lights for his lane only; and b) accelerating from the starting line position upon lighting of the lowermost of the three yellow lights.

The invention will now be described in detail in connection with the drawings identified below.

### BRIEF DESCRIPTION OF THE DRAWINGS

FIG. 1 is a front elevation view of a tree-blocking card in accordance with a first embodiment of the invention;

FIG. 2 is a view similar to FIG. 1 but with the tree-blocking card reversed; and

FIG. 3 is a perspective view of the tree blocking card, showing how the viewing apertures line up with certain lights on the starting tree.

### DETAILED DESCRIPTION OF THE INVENTION

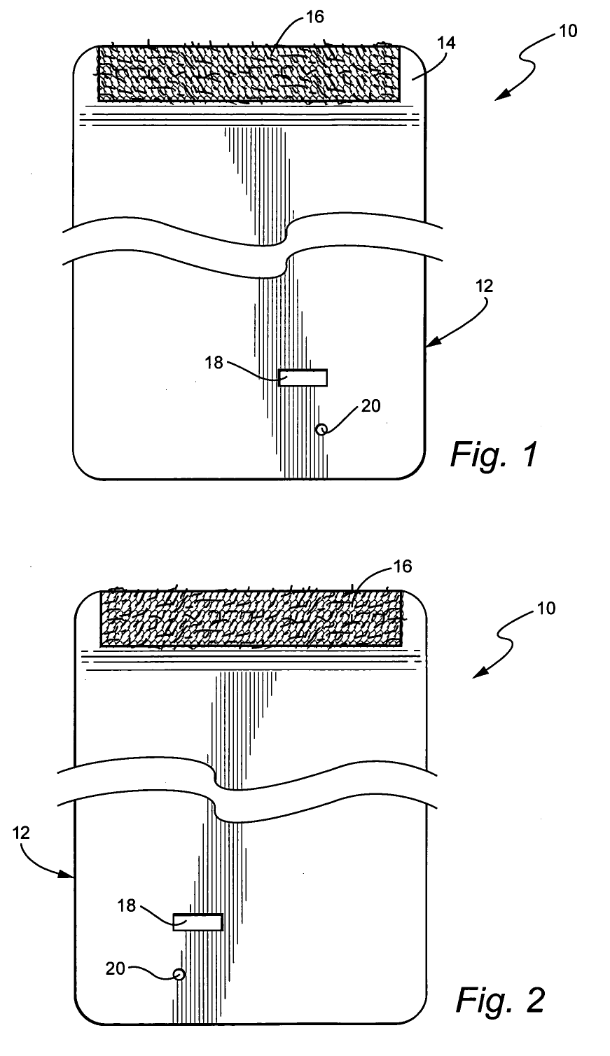

Referring to FIG. 1, a starting line enhancement device or tree-blocking card 10 in accordance with an exemplary embodiment of the invention includes a square or rectangular card body 12 (for example, 4×4 inches) that may be constructed of fairly rigid but somewhat flexible PVC, cardboard, stiff paper board, plastic, thin metal or any other suitable material. It may be desirable to use a material with shape memory characteristics so as to permit bending and re-bending at different angles to precisely locate that portion of the card having the viewing apertures (described below) relative to the attachment portion of the card. The thickness of the card body may vary as desired and in the exemplary embodiment, may have a thickness of about 0.035 in. The upper end 14 of the device may be provided with discrete hook-and-loop type fastener strips 16 (for example, a Velcro-type fastening material) on its front and back side that is adapted to cooperate with a complimentary strip of similar fastening material on the windshield, windshield molding, or roll cage of the race car. Alternatively, a single strip 16 may be used, wrapped about one or both side edges of the card.

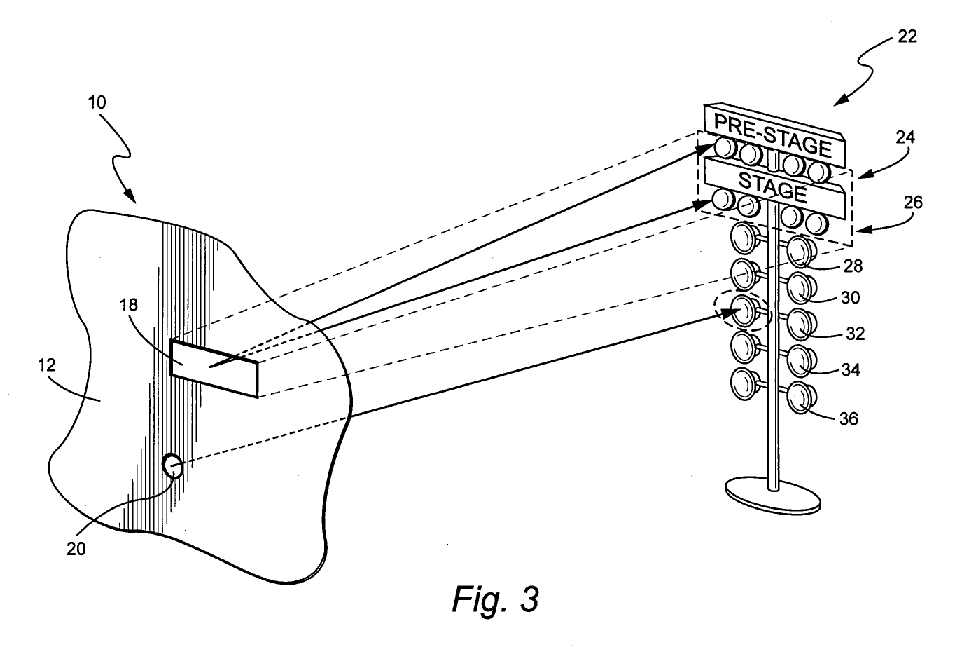

The card body 12 is formed with a pair of perforations including a rectangular aperture 18 of about ½ inch in length and 3/16 inch in width, and a round hole 20 of approximately 3-32 inch diameter that is positioned in substantial alignment with the left edge of aperture 18 and approximately 7/16 of an inch below the lower edge of the aperture 18. This positional relationship has been determined by the fixed dimensions of the standard Christmas tree light 22 (FIG. 3) used in all officially sanctioned drag races, such that once the driver has located the pre-stage and stage lights (24, 26) in the aperture 18, preferably the third yellow (or amber) light 32 will be visible in the round aperture 20. It will be appreciated that the round aperture could also be located so as to make one of the other lights visible, for example, the green light 34. The third yellow light 32 has been chosen in the exemplary embodiment in the belief that starting on the third yellow gives the driver the best opportunity for a quick getaway from the starting line, but without leaving prematurely.

With reference now to FIG. 3, when fastened in the desired location in the race car, the rectangular aperture 18 enables the driver to see the prestage and stage lights 24, 26 on both sides of the tree, i.e., for both drivers in the two side-by-side lanes, while the smaller, round aperture 20 enables the driver to see only the third yellow light 32 in his column, i.e., for his lane only.

This is particularly helpful since the sequence of yellow lights beneath the pre-stage and stage lights will not turn on until both cars have completed the pre-stage and stage movements.

When the driver sees that the stage lights 26 on both sides of the tree are lit, his focus will change to the round aperture 20 showing only the third yellow light 32 on the drivers side of the tree, since the driver is now not at all concerned with the sequence of yellow lights for the other car. When the third yellow light 32 on the driver's side comes on, the driver will accelerate, with the anticipation that reaction time is such that the car will not move across the starting line until the green light comes on.

With this arrangement, once the driver locates the pre-stage and stage lights in aperture 18, the driver will substantially maintain his or her head position, with the third yellow light automatically visible through the round aperture 20 with only a slight shift of the driver's eyes. In other words, the apertures 18 and 20 are sized and located relative to each other such that the driver can see the prestage and stage lights for both drivers via aperture 18, and then shift focus to the round hole 20 to see when the third yellow light comes on for his lane, without having to shift head position and without having to manually adjust the card.

It will be appreciated that the size and shape of the card device 10, as well as the size and shape of the apertures 14 and 16 may be altered without departing from the scope of the invention. The more significant aspect is the spatial relationship between the two apertures, and the relationship between the location of the round aperture 20 and the designated lane. It is also to be understood that the card device need only be adjusted in minor respects, with consideration given to the driver's height and position when seated in a particular car with the desired seat adjustment. It will also be appreciated that the orientation of the device is lane dependent, i.e., the round aperture 20 must be to the right when in the right lane and to the left when in the left lane. Thus, if the driver's designated lane is switched from left to right, the card can simply be reversed to accommodate the change (see FIGS. 1 and 2).

The above described card 10, and two or more strips of fastener material 16 may also be packaged in kit form. The card 10 may be provided initially with an extended length so that it can be later trimmed to meet the driver's requirements (e.g., from 8 inches to about 4), when the card is matched up with a particular vehicle and with the driver seated in that vehicle in a race position. Following trimming, one fastener strip 16 may be wrapped about the opposite upper edges of the card, thus, facilitating attachment in one orientation to the second fastener strip attached to the car, and reversal of the card to a second orientation if and when lanes are switched. With the second strip of material fastened directly to the vehicle, and given the nature of a hook-and-loop type fasteners, it is possible that minor lateral and/or vertical adjustments of the card 10 can be made without also adjusting the fastener strips.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A device for focusing a race car driver's vision on selected lights of a drag racing light tree comprising a card body having a pair of apertures formed therein; a first fastener component adapted to be attached to a vehicle on or in proximity to a windshield of the vehicle and a second fastener component secured to said card body thereby permitting attachment of said card body to the vehicle; and wherein said pair of apertures are sized and shaped to permit the driver of the vehicle to see only the selected lights of the light tree.

2. The device of claim 1 wherein one of said pair of apertures is rectangular in shape and the other of said pair of apertures is round in shape.

3. The device of claim 2 wherein said round apertures is below said rectangular aperture and aligned with one side edge of said rectangular aperture.

4. The device of claim 2 wherein the light tree is fitted with a plurality of lights of each of two adjacent track lanes, the plurality of lights for each lane including, in column form, pre-stage lights, stage lights, three yellow lights, a green light and a red light and wherein said rectangular aperture is sized and shaped to permit viewing of the pre-stage and stage lights for both lanes, and the round aperture is sized and shaped to permit viewing a lowermost of the three yellow lights only for the driver's lane.

5. The device of claim 3 wherein the light tree is fitted with a plurality of lights of each of two adjacent track lanes, the plurality of lights for each lane including, in column form, pre-stage lights, stage lights, three yellow lights, a green light and a red light and wherein said rectangular aperture is sized and shaped to permit viewing of the pre-stage and stage lights for both lanes, and the round aperture is sized and shaped to permit viewing a lowermost of the three yellow lights only for the driver's lane.

6. The device of claim 3 wherein said round aperture is substantially 7/16 inch below said rectangular aperture.

7. The device of claim 6 wherein said rectangular aperture is ½ inch long by 3/16 inch wide and said round aperture has a diameter of 3/32 inch.

8. The device of claim 7 wherein said card body is at least 4 inches wide and 4 inches long.

9. The device of claim 1 wherein said card body is comprised of PVC.

10. A card for blocking all of a plurality of lights on a drag racing light tree with the exception of a selected minority of said lights, said card comprising a card body formed with a relatively larger aperture and a relatively smaller aperture, wherein said relatively larger aperture enables viewing of more than one of said selected minority of said lights and said relatively smaller aperture enables viewing of only one other of said selected minority of said lights.

11. The card of claim 10 wherein said relatively smaller aperture is located relative to said larger aperture such that said more than one of said selected minority of lights and said only one other of selected minority of lights can be viewed substantially simultaneously.

12. The card of claim 11 wherein said larger aperture is about ½ inch long by 3/16 inch wide and said smaller aperture has a diameter of 3/32 inch.

13. The card of claim 12 wherein said round aperture is substantially 7/16 inch below said rectangular aperture and aligned with one side edge of said rectangular aperture.

14. The card of claim 11 wherein a fastener strip is secured to both sides of said card body, along an upper edge thereof.

15. A kit for use in assisting a driver at the start of a drag race wherein starting of the race is governed by a light tree, the kit comprising a card body having at least a pair of light locating apertures therein; and at least one strip of fastener material sufficient to provide a first length of said fastener for application to a selected location on both sides of said card and a second strip of a complimentary fastener material adapted for attachment to a race vehicle thereby enabling said card body to be attached to the vehicle by interaction between said first and second strips of fastener material.

16. A method of enabling a driver of a race car to effect a quick start from a starting line position in a drag race where the start of the race is governed by a light tree having, for each of two competing drivers in adjacent lanes, a pair of side-by-side pre-stage lights, a pair of side-by-side stage lights, and a column of single lights including three yellow and a green light, the method comprising:
a) partially restricting vision of the driver so that, of all of the lights on the tree, he can see only the pre-stage and stage lights for both lanes and the lowermost of the three yellow lights for his lane only; and
b) accelerating from the starting line position upon lighting of the lowermost of the three yellow lights.

17. The method of claim 16 wherein step (a) is carried out by attaching a reversible tree-blocking card in proximity to a windshield of the driver's race car, the tree blocking card having one aperture for viewing the pre-stage and stage lights for both lanes and a second aperture for viewing the lowermost yellow light for the driver.

18. The method of claim 17 and including an additional step of reversing the card in the event the driver starts from the adjacent lane.

19. The method of claim 17 wherein step (a) is further carried out by utilizing complimentary fastener materials on both sides of the card and on the race car to thereby facilitate attachment, adjustment and reversal of the cards.
